(19) United States
(12) Patent Application Publication
(10) Pub. No.: US 2024/0294318 A1
(43) Pub. Date: Sep. 5, 2024

(54) SYSTEMS AND METHODS FOR DISTRIBUTING AND DISPENSING PERSONAL SERVINGS OF CHOCOLATE

(71) Applicant: True Essence Foods Inc., Indianapolis, IN (US)

(72) Inventors: Matthew Rubin, Indianapolis, IN (US); Adam Ambrecht, Kennesaw, GA (US)

(21) Appl. No.: 18/442,213

(22) Filed: Feb. 15, 2024

Related U.S. Application Data
(63) Continuation of application No. 17/136,394, filed on Dec. 29, 2020.
(63) Continuation of application No. 16/792,648, filed on Feb. 17, 2020, now Pat. No. 11,272,721.
Application No. 16/792,648 is a continuation of application No. 14/879,997, filed on Oct. 9, 2015, now Pat. No. 10,609,937.
(60) Provisional application No. 62/954,826, filed on Dec. 30, 2019.
(60) Provisional application No. 62/061,856, filed on Oct. 9, 2014.
(60) Provisional application No. 62/115,339, filed on Feb. 12, 2015.

(51) Int. Cl. B65D 75/30; A23G 1/00; B32B 15/085; B32B 15/088; B32B 15/09; B32B 15/18; B32B 15/20; B65B 3/02; B65B 3/04; B65B 25/00; B65D 75/26; B65D 75/58; B65D 85/60

(52) U.S. Cl. CPC B65D 75/30; A23G 1/0013; A23G 1/0066; B32B 15/085; B32B 15/088; B32B 15/09; B32B 15/18; B32B 15/20; B65B 3/02; B65B 3/04; B65B 25/005; B65D 75/26; B65D 75/5805; B65D 75/5811; B65D 75/5822; B65D 85/60; B32B 2307/582; B32B 2307/7246; B32B 2439/70; B65D 2565/387

(57) ABSTRACT

A multilayered, flexible, and generally flat pouch for transporting and dispensing chocolate, including first and second elongated generally rectangular multilayered portions sealed together to yield a deformable generally rectangular fluid-tight sachet defining an internal volume and separating the internal volume from an external environment. The sachet further defines a top end, an oppositely disposed bottom end, and first and second sides extending therebetween. An untempered chocolate portion is contained within the internal volume. A tear notch is formed through at least one side and disposed adjacent the top end and a weakened tear strip extends between the second side and the bottom end. The sachet is substantially fluid-tight, and first and second elongated generally rectangular multilayered portions each further comprise an outer layer, an inner high-slip layer, a printable binding layer disposed between the inner and outer layers, and a metal vapor barrier layer disposed between the inner and outer layers. When actuated, the first weakened tear strip produces a corner pour spout through which molten chocolate may be extracted from the sachet. When actuated, the second weakened tear strip produces a central aperture through which molten chocolate may be extracted from the sachet.

### CROSS-REFERENCE TO RELATED APPLICATIONS

This patent application claims priority to co-pending U.S. patent application Ser. No. 17/136,394, filed on Dec. 29, 2020, which claims priority to then co-pending U.S. provisional patent application No. 62/954,826, filed on Dec. 30, 2019; this application also claims priority to issued U.S. patent application Ser. No. 16/792,648, filed on Feb. 17, 2020, which was a continuation of then co-pending U.S. patent application Ser. No. 14/879,997, filed on Oct. 9, 2015, which claimed the benefit under 35 U.S.C. § 119 (e) of then co-pending U.S. Provisional Patent Application No. 62/061,856, entitled “Systems and Methods for Distributing and Dispensing Chocolate,” filed Oct. 9, 2014, and also of then co-pending U.S. Provisional Patent Application No. 62/115,339, entitled “Systems and Methods for Distributing and Dispensing Chocolate,” filed Feb. 12, 2015, which are incorporated herein by reference in its entirety.

### TECHNICAL FIELD

The invention disclosed herein relates generally to the field of food storage and dispensing, and more particularly, to a systems and methods for storing and dispensing solid and molten food contents.

### BACKGROUND

Chocolate, a homogenous suspension of cacao nibs/cacao powder, sugar, and cacao butter, and having a relative moisture content of less than 3% by weight, has been of economic and culinary interest for many years. Chocolate is typically solid at room temperature, and may form a liquid suspension or melt, at temperatures above the melting point of its fat crystals, conventionally above 34° C.

In all cases, melted or molten chocolate is characterized by a relatively high viscosity compared to chocolate solutions, such as chocolate milk or other chocolate-containing drinks, and unlike high water content chocolate drinks, chocolate is solid at 21° C. and must be melted in order to achieve a reasonable working viscosity. In this sense, chocolate may be considered a composite material characterized by a fatty, or hydrophobic matrix rather than an aqueous or hydrate matrix.

While ready-to-eat chocolate traditionally includes cacao nibs and sugar, other materials such as cacao butter, vegetable oil, milk powder, soy lecithin, ground vanilla bean, and/or nuts are often added to increase the sweetness, decrease the viscosity, dampen the flavor, and/or stabilize the chocolate suspension.

Like many melted suspensions, a chocolate melt will separate over time if left undisturbed resulting in a high cacao butter content layer near the top of the melt, and a high cacao and sugar particle content layer settling toward the bottom. Melt separation is one of the factors that drove the chocolate industry to store and distribute chocolate in solid, tempered formats including beta-V crystals, which melt at approximately 34° C. In order to produce tempered chocolate, molten chocolate is heated above 37° C. to melt all crystal morphologies, cooled to approximately 28° C. to produce type IV and V crystals, and reheated to approximately 32° C. to melt the type IV crystals resulting in pure beta-V seed crystals that may propagate to form a solid bar upon rapid cooling. Rapid cooling is traditionally achieved through the use of large and expensive forced-air cooling tunnels.

Unlike chocolate melts, tempered chocolate may preserve a consistent particle distribution for several months or years so long as it is stored in a cool and dry environment. If storage temperatures rise above 27° C., the crystalline state of tempered chocolate will soften and may result in migration and precipitation of cacao butter on the surface of the chocolate, resulting in a characteristic white flakey appearance on the surface known as ‘fat bloom’.

Storing chocolate in humid environments may cause a similar problem known as sugar bloom where the sugar in the chocolate becomes saturated with excess moisture from the atmosphere and precipitates as tiny white spots on the surface of the chocolate, with a characteristic appearance similar to fat bloom. The beta-V crystal structure of cacao butter has a high density relative to amorphous chocolate or chocolate with other crystalline structures, resulting in a moisture resistant hard composite. Traditionally, the tempering process may be used to help store chocolate over a longer period of time in a relatively moisture-stable form as compared to amorphous chocolate.

Sugar and fat bloom are undesirable characteristics in finished chocolate goods, and often result in consumers either returning or disposing of their purchased goods. Cold chain distribution systems with refrigerated transports and storage facilities are traditionally necessary to avoid sugar and/or fat bloom. While this method of transport is effective, it greatly adds to the cost and complexity of delivering chocolate goods.

Thus, there is a need for a system and method that may enable convenient distribution of untempered chocolate through relatively uncontrolled environments, without having to resort to the expense of tempering the chocolate and the expense of refrigerated transport. The present novel technology addresses these needs.

### BRIEF DESCRIPTION OF THE DRAWINGS

FIGS. 1A-1H illustrate a rectangular single serving chocolate pouch with opposing solid and melted access ports.

FIG. 2A-2H illustrate a generally rectangular single serving chocolate pouch with opposing solid and an attenuated tail-like structure including a melted access port.

FIG. 3A-D illustrate a generally circular single serving chocolate pouch with a central solid access port and a spaced melted access port.

FIG. 4 is a cross-sectional partial perspective view of a multilayered material from which the pouches of FIGS. 1A-3D are made.

FIG. 5A-D are schematic views of the embodiment of FIG. 1 showing typical dimensions (units expressed in millimeters).

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

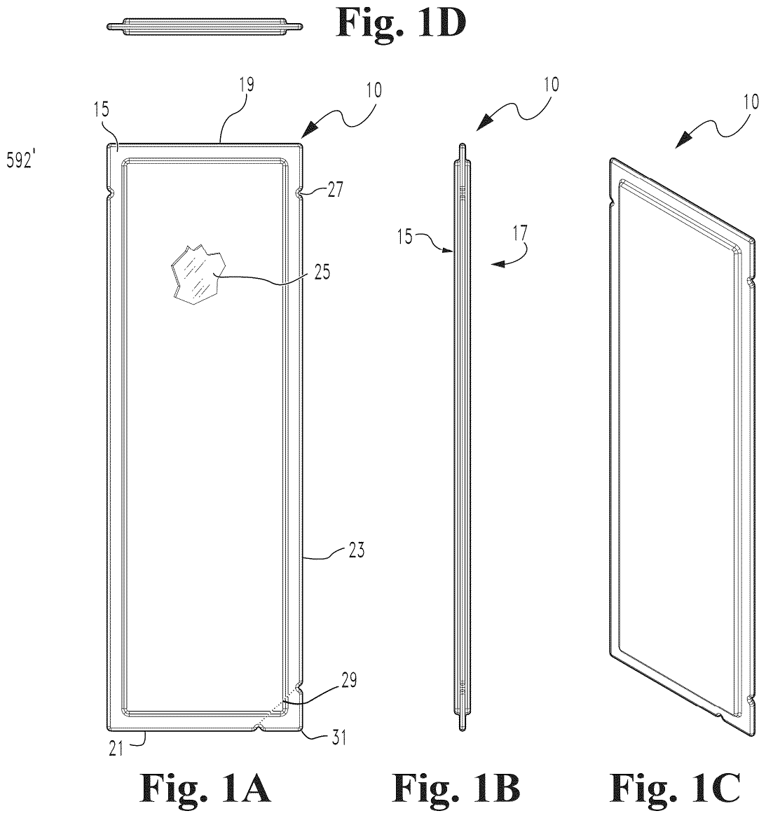

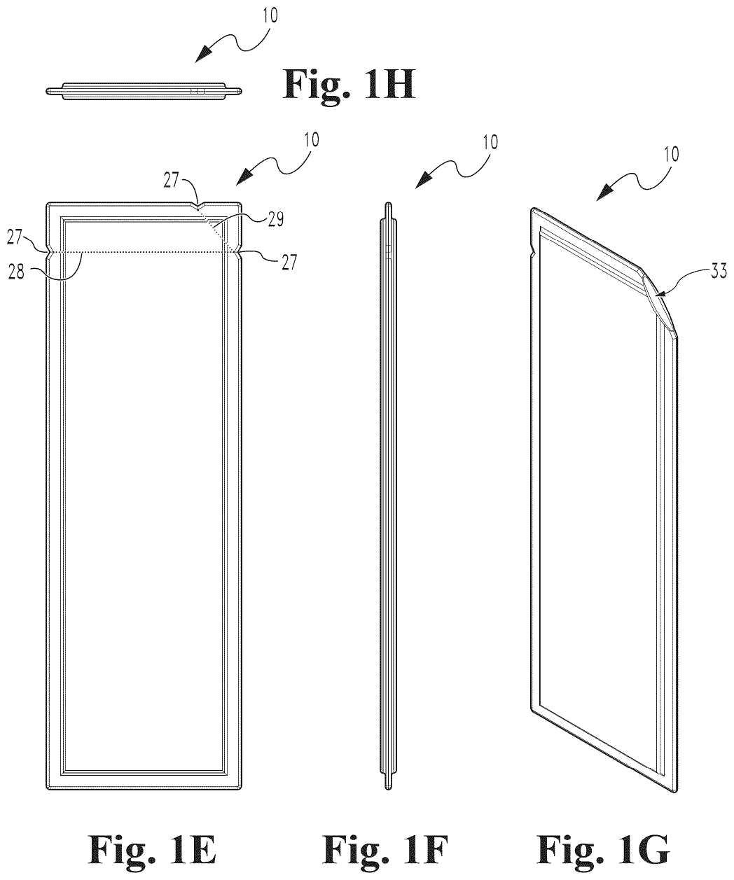

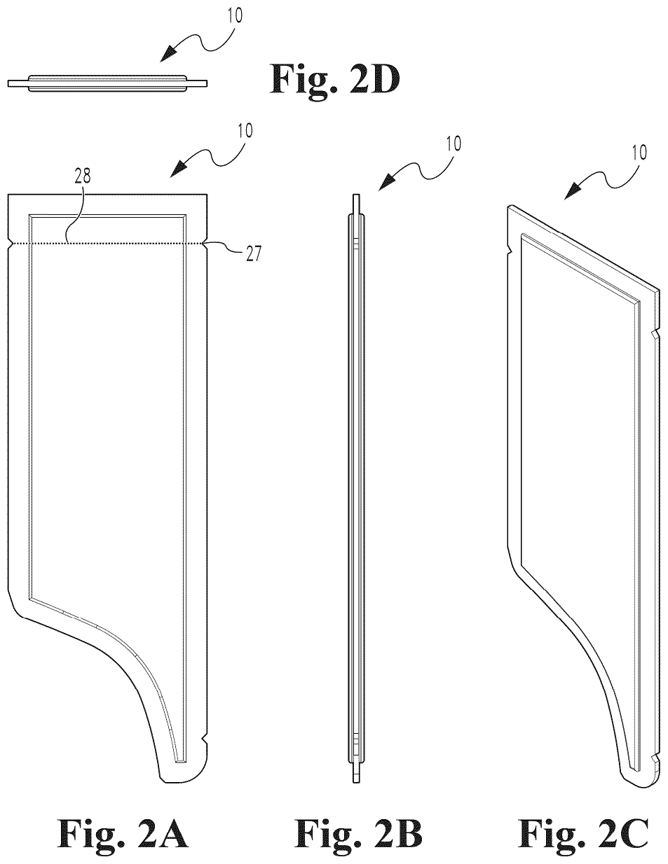

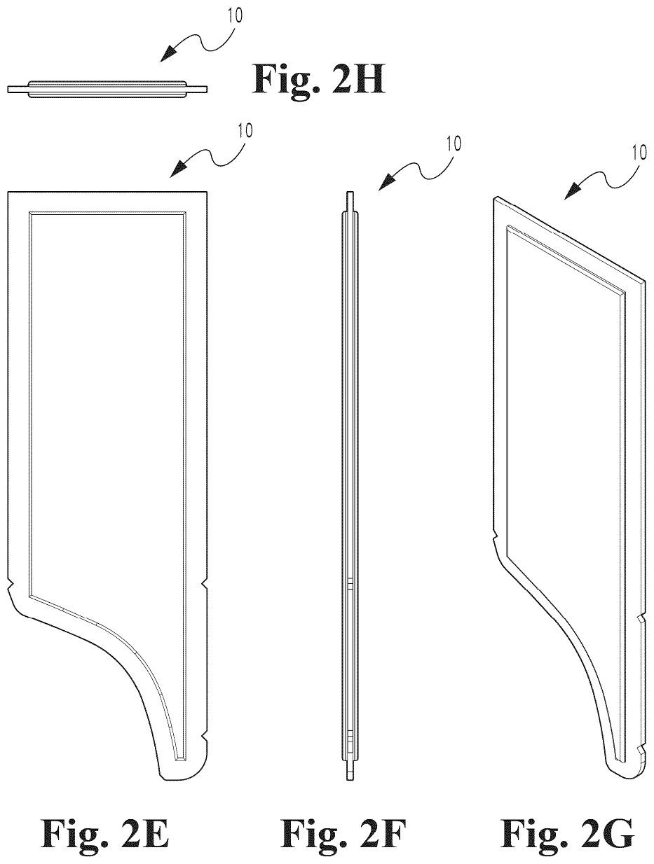

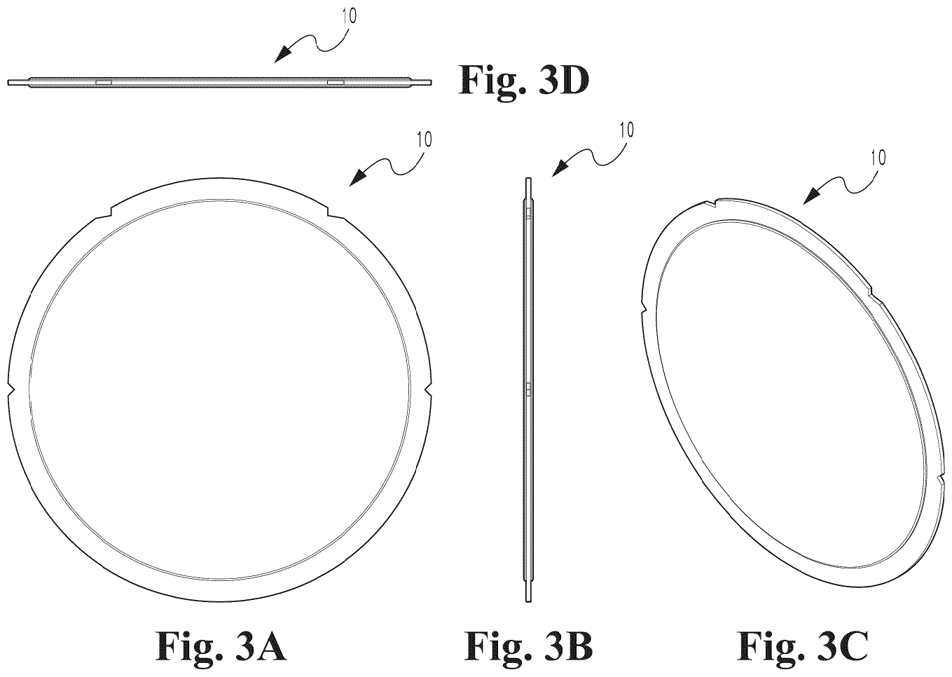

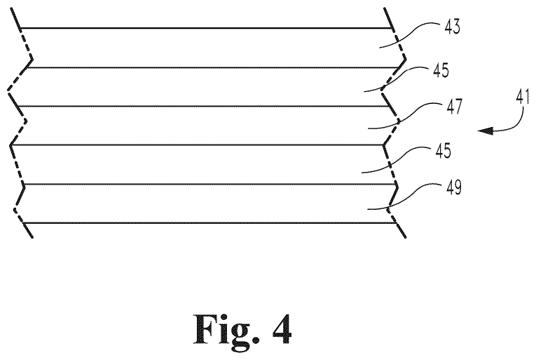

As shown in FIG. 1, the present novel technology relates to a flexible individual serving pouch or packet system 10 for containing and delivering chocolate. The pouch system 10 includes elongated, typically generally rectangular front and rear panels 15, 17 joined together at top, bottom and side seals 19, 21, 23 to define an internal containment volume 25. Typically, one or more tear notches are formed through side seal(s) 23 to act as stress concentrators for starting and directing a tear opening at or near the top seal 19. The tear notches typically do not intrude into the pouch interior product volume. The sides are typically heat sealed together to define a seal width of typically between 3.175 and 9.525 millimeters (mm). Likewise, packet 10 may also include a partially perforated or otherwise weakened seam 29 across a corner 31 of the pouch 10 to, once torn, define a pour spout 33. However, this pre-weakened seam is not a necessary requirement and is sometimes used to simply define the shortest tear path between notches. In some embodiments, the pouch 10 has a generally rectangular shape narrowing tail extending therefrom (see FIG. 2) and in others, the pouch has a circular shape (see FIG. 3). Generally, the pouch may have a predetermined geometric shape, such as a circle, a square, a rectangle, a triangle, a right circular cylinder, or the like.

Pouch 10 is typically made of a flexible, multilayer foil and/or film material 41, and may include an outer layer 43 (such as aluminum foil, PET (polyethylene terephthalate) coated polyester or the like) that is typically transparent, at least one binding layer 45 (such as aluminum foil, LDPE (low-density polyethylene), HPC (hydroxypropyl cellulose), EAA (ethyl acetoacetate), or the like) that may be printable (typically through an offset printing process) and have a white, transparent, natural, or colored background, a vapor barrier layer 47 (such as aluminum foil, steel foil, copper foil, metal foil, or the like) for preventing loss of flavor by outgassing, dissolution, and/or like mechanism, and an inner layer 49 (such as aluminum foil, LLDPE (linear low-density polyethylene), nylon EVOH (ethylene vinyl alcohol) coex film, HDPE (high density polyethylene), EVA (ethylene vinyl acetate), metallocene, MDPE (medium density polyethylene), VLDPE (very low density polyethylene), LDPE (low density polyethylene, or the like) for directly contacting chocolate preferably of a low friction or high-slip film. In some cases, low permeability vapor barriers, such as aluminized polyester may be used as barrier 47 for low volatility products. Chocolate filling the inner volume 25 may be in either solid or liquid state. For untempered chocolate contained in the present pouch, transition from solid to liquid and/or liquid to solid may occur any number of times without degradation due to environmental exposure and without separation due to the high aspect ratio of the pouch surface area vs volume, thus enabling chocolate filled pouches to be transported without any temperature control. In other words, chocolate contained in the pouch 10 requires neither tempering nor a cold chain distribution system, and thus may be prepared and transported cheaply and efficiently.

A method of molding chocolate containing the following steps is presented herein. First, a partially sealed pouch (typically sealed on 3 sides for a typical rectangle) is formed from a single, or, more preferably, a multilayer film. The pouch acts as a disposable mold for forming a generally bar-shaped chocolate serving. The partial opening is then separated to reveal the inner pouch volume, where a nozzle is plunged partially into the volume, and deposits untempered chocolate. The nozzle preferably contains a suck-back function where a partial volume of chocolate is drawn into the volume of the nozzle tip removing any drips or tail, and still more preferably, an atmospheric blow-off nozzle may be used to clear any drips or tails while injecting an additional volume of air, wherein the atmosphere is introduced into a tube nested within the fill tube volume and extruded through the fill tip following filling, preferably an inert atmosphere such as nitrogen or argon, into the pouch while clearing the tip. The pouch opening may then be stretched, and the volume of sealed chocolate may be depressed from an external press, thereby decreasing any headspace, or residual atmosphere in the pouch, and finally sealed at the opening to produce an isolated chocolate environment. The residual headspace is typically less than 25%, more typically less than 15%, and still more typically less than 10% of the total pouch volume. This enables nearly constant communication of the chocolate with both pouch walls to promote the formation of a pseudo-temper crystal.

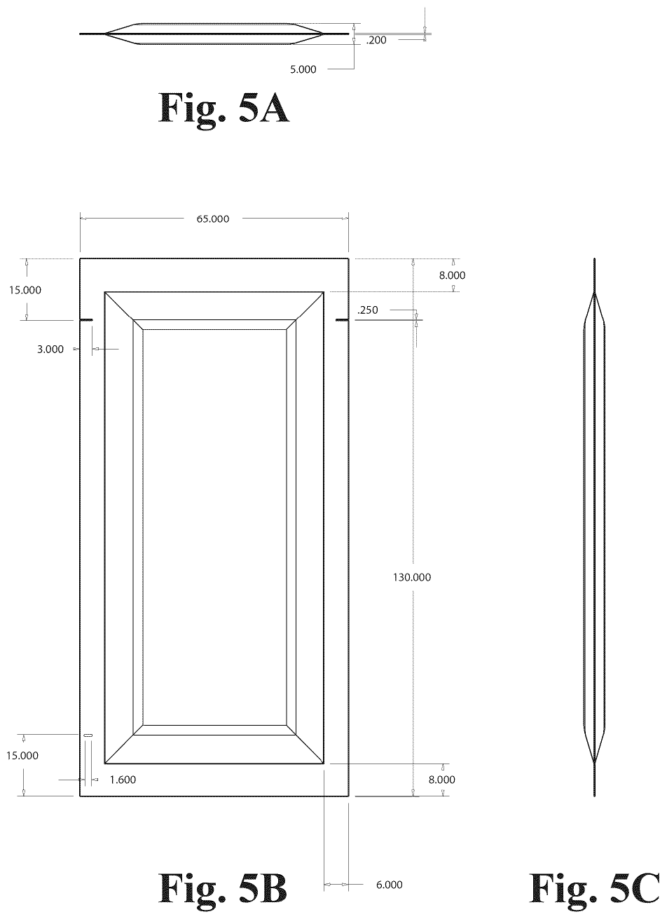

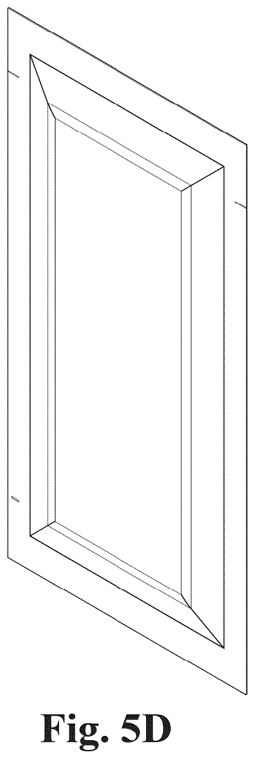

The pouch may be further depressed once it is filled to distribute the product evenly within the container. This may be done actively through mechanical intervention or passively by placing horizontally during cooling. The pouch may further be depressed such that the majority of the chocolate is maintained below the solid chocolate tear notches. In the case of one of the present embodiments in FIG. 5, this point would be below the top 15 mm of total pouch height, or 7 mm of total internal volume. A pouch formed under the present method is preferably a high aspect-ratio pouch of sealed chocolate with an average cross-sectional surface area of between 75 and 350 square millimeters per gram, which is typically no greater than 12 mm thick at the peak thickness, more preferably no more than 10 mm thick at the peak thickness, and still more preferably no more than 8 mm thick at the peak thickness, and which includes the typically 25% or less headspace disposed evenly across the volume. A cross-sectional surface are may be viewed as the surface area of one side of column of material. The combination of the high aspect ratio, high-slip inner film, which is preferably high-slip LLDPE, and low atmospheric head space enable the formation of a quasi-stable pseudo-temper crystalline structure with a high degree of type V beta crystals to form without thermal cycling or rapid cooling in a cooling tunnel (typically 13° C.). This polycrystalline formation is able to exhibit the characteristic chocolate snap for days, weeks, or months following molding without the formation of substantial chocolate bloom. This combination of pouch features (the inner film high slip surface, high aspect ratio, and low air volume) enable the formation of type V beta crystals through chocolate-film interactions that may diffuse at least 6 mm into the bulk chocolate, more typically at least 5 mm into the bulk chocolate, and still more typically at least 4 mm into the bulk chocolate, rather than through traditional thermal cycling, enabling a product to be shipped through a variety of ambient environments and re-seed additional type V crystals, thereby preserving the product quality without cold-chain shipping. The formation of type V beta crystals may be further enhanced by placing the chocolate product in a vacuum environment of less than 50 Torr, more specifically, less than 35 torr, more specifically less than 25 torr, and still more specifically between 22 and 8 torr at a temperature between 38° C. and 49° C., more specifically between 41° C. and 46° C., and still more specifically approximately 43° C. for at least 5 seconds, more specifically at least 10 seconds prior to returning to ambient pressure. This removes microscopic air bubbles, adjusts the pH of the chocolate through the removal of volatile acids, and adjusts the flavor through the removal of other volatile molecules. Results have shown a superior pseudo-temper stability of chocolate processed in this manner prior packaging as compared to conventional techniques.

This method may be followed by a method of tempering chocolate, wherein a high aspect ratio pouch of sealed chocolate with a surface area of between 75 and 350 square millimeters per gram is placed first in an environment above 37° C. for at least five seconds, more preferably at least 10 seconds, then placed in cooler environment and/or contact surface of less than 29° C. for at least five seconds, more preferably at least 10 seconds, and then reheated in an environment between 32° C. and 34° C. for at least five seconds, more preferably at least 10 seconds, and finally cooled in an environment of less than 27° C., more preferably, less than 21° C., and still more preferably less than 18° C. for at least five seconds, more preferably at least 10 seconds.

Chocolate contained in a pouch 10 may be served in solid or liquid form. For solid form service, the pouch 10 may simply be torn open, typically along a predetermined solid access line 28, such as by applying torsional forces to the tear notch(es) 27. The solid access line 28 is typically positioned at a location of maximum cross-sectional opening within an extraction direction so as to enable the chocolate contents of the pouch 10 to be easily removed without interference. The pouch 10 portions 15, 17 may then simply be peeled away from the solid chocolate payload which may then be extracted and enjoyed.

For liquid service, the pouch 10 may be immersed in water between 38° C. and 49° C. for about ten seconds until the contents are fully melted. Alternatively, the pouch 10 may be mechanically agitated repeatedly to melt and loosen the chocolate, or otherwise heated by any convenient process. Once the contained chocolate is molten, the corner tear strip or liquid access line 29 may be utilized to open a corner spout 31, and the liquid chocolate may be slowly poured or squeezed out and enjoyed. The liquid access port or line 29 may be located adjacent or overlapping the solid access port or line 28 to reduce the number of tear notches and/or to facilitate consistent access location. Conversely, the liquid access port 29 may be located away from the solid access port or line 28 to enable deliberate access to the liquid dispensing.

Pouch 10 is typically formed as a sachet, insofar as the seals 19, 21, 23 operate to manage the tension on the panels 15, 17 to maintain the flat, rectangular shape of the packet 10 when filled with chocolate and to maximize the sachet 10 surface area. The sachet 10 is typically prepared in a ‘form, fill, and seal’ operation, more typically under an inert atmosphere, such as positive pressure N2, to yield chocolate filled and sealed sachets 10. However, the pouch 10 could have any other convenient shape, such as shown in the drawings, or such as cylindrical, if a single side seal 23 is opted.

In operation, a serving of chocolate may be provided by partially sealing two multilayer sheets together to yield an open enclosure. The open enclosure is filled with untampered chocolate, typically under an inert atmosphere, and the two multilayer sheets are sealed together to fully enclose the chocolate, yielding a sachet containing one serving of chocolate. The sachet is then transported to a purchaser at ambient temperature. The chocolate-filled sachet is stable against fat and sugar blooms for at least ten years.

In one embodiment, the pouch 10 typically measures 130 mm by 65 mm by 5 mm (thickness when filled with chocolate within the fill volume). In other embodiments, the pouch 10 typically measures between 70 and 200 mm in length and between 30 and 90 mm in width, with a thickness between 2 and 8 mm when filled. In still other embodiments, the pouch shape, dimensions, thickness, and layer arrangement may be varied as desired.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A multilayered, flexible, and generally flat pouch for transporting and dispensing chocolate, comprising:
a first elongated generally rectangular multilayered portion sealed to a second elongated generally rectangular portion to yield a deformable multilayered, flexible, and generally flat pouch defining an internal volume and separating the internal volume from an external environment, wherein the multilayered, flexible, and generally flat pouch further defines a top end, and oppositely disposed bottom end, and first and second sides extending therebetween;
an untempered chocolate portion contained within the internal volume;
a tear notch formed through at least one respective side and disposed adjacent the top end;
an access line extending between the second side and the bottom end;
a weakened seam extending between the first and second sides and spaced from the first weakened tear strip.

2. The multilayered, flexible, and generally flat pouch for transporting and dispensing chocolate of claim 1, wherein the first and second elongated generally rectangular multilayered portions each further comprise:
an outer layer;
an inner food contact layer;
a binding layer disposed between the inner and outer layers; and
a metal foil vapor barrier layer disposed between the inner and outer layers;
wherein actuation of the weakened seam produces a corner pour spout through which molten chocolate may be extracted from the sachet.

3. The multilayered, flexible, and generally flat pouch for transporting and dispensing chocolate of claim 2 wherein the inner, outer, and metal foil vapor barrier layers are aluminum.

4. The multilayered, flexible, and generally flat pouch for transporting and dispensing chocolate of claim 2 wherein the outer layer is selected from the group comprising PET and polyester; wherein the inner food contact layer is selected from the group consisting of LLDPE, HDPE, EVA, metallocene, MDPE, VLDPE, LDPE, and nylon EVOH coex film; wherein the binding layer is selected from the group consisting of LDPE, HPC, and EAA; and wherein the metal foil vapor barrier layer is selected from the group consisting of aluminum foil, steel foil, and copper foil.

5. A multilayered, flexible, generally flat sachet for containing a serving of chocolate, comprising:
a first multilayered sheet of a predetermined geometric shape sealed to a second identically-shaped sheet to yield a deformable multilayered, flexible, generally flat sachet defining an internal volume and an outer edge separating the internal volume from an external environment;
an untempered chocolate serving contained within the internal volume; and
a first tear notch formed through the multilayered, flexible, generally flat sachet.

6. The multilayered, flexible, generally flat sachet of claim 5, and further comprising a second tear notch formed through the multilayered, flexible, generally flat sachet and spaced from the first tear notch; wherein the access line extends between the first tear notch and the second tear notch.

7. The multilayered, flexible, generally flat sachet of claim 5, wherein the predetermined geometric shape is selected from the group comprising a circle, a rectangle, a square, and a triangle.

8. The multilayered flexible, generally flat sachet of claim 5 wherein the first and second multilayered sheets each further comprise:
an outer layer;
an inner food contact layer;
a binding layer disposed between the inner and outer layers; and
a metal foil vapor barrier layer disposed between the inner and outer layers; and
a weakened seam formed therethrough;
wherein actuation of the weakened seam produces a pour spout through which molten chocolate may be extracted from the sachet.

9. The multilayered flexible, generally flat sachet of claim 8 wherein the inner, outer, and metal foil vapor barrier layers are aluminum.

10. The multilayered flexible, generally flat sachet of claim 8 wherein the outer layer is selected from the group comprising PET and polyester; wherein the inner food contact layer is selected from the group consisting of LLDPE, HDPE, EVA, metallocene, MDPE, VLDPE, LDPE, and nylon EVOH coex film; wherein the binding layer is selected from the group consisting of LDPE, HPC, and EAA; and wherein the metal foil vapor barrier layer is selected from the group consisting of aluminum foil, steel foil, and copper foil.
